(19) United States
(12) Patent Application Publication
(10) Pub. No.: US 2016/0203316 A1
(43) Pub. Date: Jul. 14, 2016

(54) ACTIVITY MODEL FOR DETECTING SUSPICIOUS USER ACTIVITY

(71) Applicant: Microsoft Technology Licensing, LLC, Redmond, WA (US)

(72) Inventors: Daniel Lee Mace, Bellevue, WA (US); Gil Lapid Shafriri, Redmond, WA (US); Craig Henry Wittenberg, Clyde Hill, WA (US)

(21) Appl. No.: 14/597,015

(22) Filed: Jan. 14, 2015

(51) Int. Cl. G06F 21/55; G06N 7/02

(52) U.S. Cl. CPC G06F 21/55; G06N 7/02

(57) ABSTRACT

Embodiments are directed to generating an account process profile based on meta-events and to detecting account behavior anomalies based on account process profiles. In one scenario, a computer system accesses an indication of which processes were initiated by an account over a specified period of time. The computer system analyzes at least some of the processes identified in the indication to extract features associated with the processes. The computer system assigns the processes to meta-events based on the extracted features, where each meta-event is a representation of how the processes are executed within the computer system. The computer system then generates an account process profile for the account based on the meta-events, where the account process profile provides a comprehensive view of the account's behavior over the specified period of time. This account process profile can be used to identify anomalies in process execution.

### BACKGROUND

Computing systems have become ubiquitous, ranging from small embedded devices to phones and tablets to PCs and backend servers. Each of these computing systems is designed to process software code. The software allows users to perform functions, interacting with the hardware provided by the computing system. In some cases, these computing systems allow user or system accounts to initiate application processes. Typically, these processes are innocuous, and are part of the user's normal everyday tasks. However, malicious users may attempt to take over other users' accounts and perform malicious tasks.

### BRIEF SUMMARY

Embodiments described herein are directed to generating an account process profile based on meta-events and to detecting account behavior anomalies based on account process profiles. In one embodiment, a computer system accesses an indication of which processes were initiated by an account over a specified period of time. The computer system analyzes at least some of the processes identified in the indication to extract features associated with the processes. The computer system assigns the processes to meta-events based on the extracted features, where each meta-event is a representation of how the processes are executed within the computer system. The computer system then generates an account process profile for the account based on the meta-events, where the account process profile provides a comprehensive view of the account's behavior over the specified period of time.

In another embodiment, a computer system detects account behavior anomalies based on account process profiles. The computer system accesses an account process profile that includes meta-events, which are representations of how the process is executed within the computing system. The computer system determines past process behavior for the account based on the accessed account process profile including which meta-events were present in the account process profile. The computer system then generates an indication of expected deviations for a specified future period of time, where the expected deviations indicates a likelihood that the account will initiate one or more processes in a manner that is outside of the account's past behavior, or is outside of behavior of accounts similar to the account. The computer system further monitors those processes that are initiated by the account over the specified future period of time to detect anomalies, and based on the detected anomalies, assigns a suspiciousness ranking to the account profile.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including generating an account process profile based on meta-events.

FIG. 2 illustrates a flowchart of an example method for generating an account process profile based on meta-events.

FIG. 3 illustrates a flowchart of an example method for detecting account behavior anomalies based on account process profiles.

FIG. 4 illustrates an embodiment in which features are extracted from event processing logs.

FIG. 5 illustrates a process flow in which process names are reduced to a grouping that is representative of an organization and title data.

FIGS. 6A-6C illustrate various embodiments for calculating a process neighborhood similarity.

### DETAILED DESCRIPTION

Embodiments described herein are directed to generating an account process profile based on meta-events and to detecting account behavior anomalies based on account process profiles. In one embodiment, a computer system accesses an indication of which processes were initiated by an account over a specified period of time. The computer system analyzes at least some of the processes identified in the indication to extract features associated with the processes. The computer system assigns the processes to meta-events based on the extracted features, where each meta-event is a representation of how the processes are executed within the computer system. The computer system then generates an account process profile for the account based on the meta-events, where the account process profile provides a comprehensive view of the account's behavior over the specified period of time.

In another embodiment, a computer system detects account behavior anomalies based on account process profiles. The computer system accesses an account process profile that includes meta-events, which are representations of how the process is executed within the computing system. The computer system determines past process behavior for the account based on the accessed account process profile including which meta-events were present in the account process profile. The computer system then generates an indication of expected deviations for a specified future period of time, where the expected deviations indicates a likelihood that the account will initiate a process that is outside of the account's past behavior, or is outside of behavior of at least one account similar to the account. The computer system further monitors those processes that are initiated by the account over the specified future period of time to detect anomalies, and based on the detected anomalies, assigns a suspiciousness ranking to the account profile.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may implement various types of computing systems. These computing systems are now increasingly taking a wide variety of forms. Computing systems may, for example, be handheld devices such as smartphones or feature phones, appliances, laptop computers, wearable devices, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

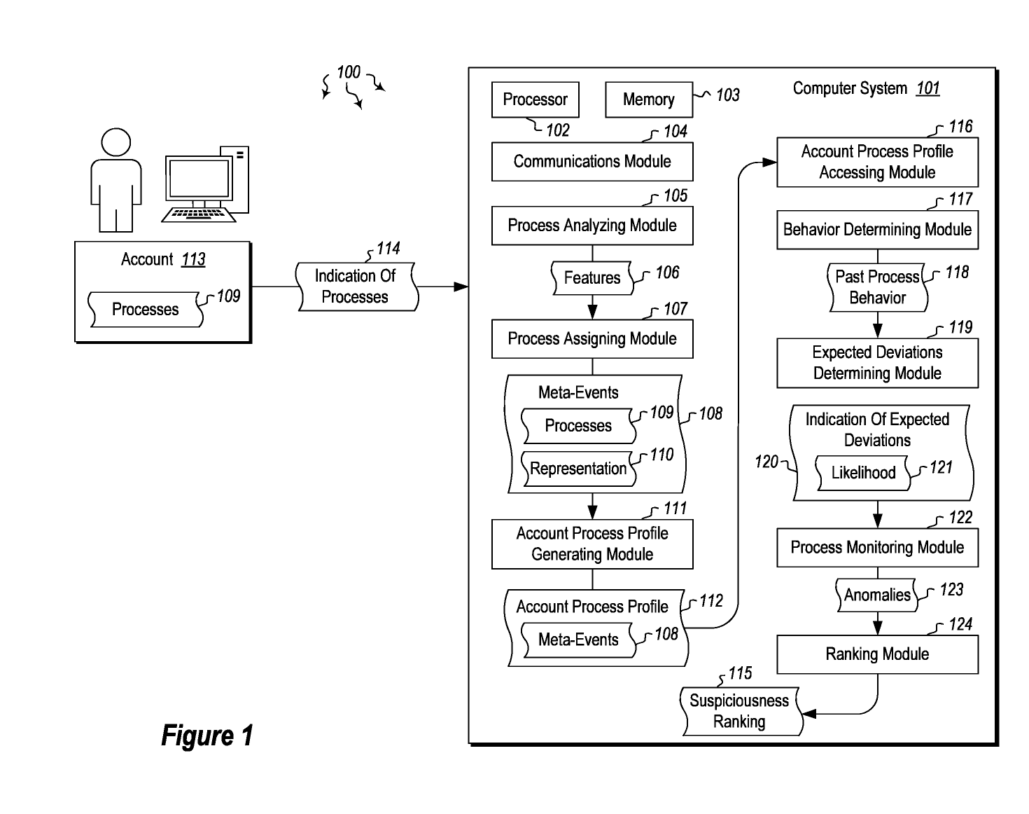

As illustrated in FIG. 1, a computing system 101 typically includes at least one processing unit 102 and memory 103. The memory 103 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 103 of the computing system 101. Computing system 101 may also contain communication channels that allow the computing system 101 to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which at least one embodiment may be employed. Computer architecture 100 includes computer system 101. Computer system 101 may be any type of local or distributed computer system, including a cloud computing system. The computer system 101 includes modules for performing a variety of different functions. For instance, the communications module 104 may be configured to communicate with other computing systems. The communications module 104 may include any wired or wireless communication means that can receive and/or transmit data to or from other computing systems. The communications module 104 may be configured to interact with databases, mobile computing devices (such as mobile phones or tablets), embedded or other types of computing systems.

The computer system 101 further includes a process analyzing module 105 which may receive an indication of 114 which processes were initiated by an account 113. The processes 109 may be any type of software functionality including a function, a method, a full application, a service or other type of software functionality. The processes 109 may be initiated by a user account, a system account or other type of account 113. The process analyzing module 105 may look at which processes were initiated by a given account and extract various features 106 related to those processes and, more specifically, to the execution of those processes 109. Many different features may be calculated or otherwise determined, as will be explained further below.

These features 106 may be passed to a process assigning module 107 which assigns the features to various meta-events 108. The meta-events may provide a representation 110 of the execution of a given process 109. The meta-events may be aggregated by the account process profile generating module 111 into account process profile 112. The account process profile 112 includes various meta-events which describe how a given process is expected to execute within the computer system 101. The account process profile accessing module 116 may access the account process profile 112 and pass it to the behavior determining module 117. The behavior determining model 117 may access past process behavior for a given process 109 and provide that past behavior to the expected deviations determining module 119 which generates an indication of expected deviations 120. This indication of expected deviations 120 provides a likelihood 121 that the process will execute within its previous execution boundaries, or will exhibit processing behavior that is similar to past process behavior 118.

In some embodiments, the process monitoring module 122 may be configured to measure behavior of a process in context of other processes and the aggregate manner in which all process are executed. This monitoring may be performed post-processing or, at least in some cases, may be performed in real time. If any anomalies 123 are found, the ranking module 124 will increase the suspiciousness ranking 115 for that process and other processes executed with similar behavior. If no anomalies are found, the ranking module 124 will decrease the suspiciousness ranking 115 for that process. This high-level overview has been provided to give a general context for the more detailed description provided below.

Detecting and alerting on suspicious activity of users through device logs is instrumental in protecting a corporation or other entity from malicious actors. Various methods and processes are described herein that allow the computer system 101 to capture and integrate a large variety of signals from process creation logs to detect abnormal and suspicious changes in behavior for users. The methods and systems described herein can be extended to any large scale event based anomaly detection problem.

Embodiments may be configured to detect suspicious behavior and activity from a fixed set of discrete events (e.g. user device login events, administrative actions, etc.). The activity model described herein may be extended to a non-parametric setting where the number of events is potentially unbounded (i.e. there may be an infinite amount of ways that users can execute and run processes on a device that can't be practically enumerated through events).

This may be accomplished by creating intermediate meta-events 108 that describe the behavior of any possible process execution. Meta-events are a set of events that collapse a large sets of events into a shared event. The meta-events may be generated by calculating features based on the process and execution that describe the process being executed. This can be events such as: a new process not seen before, a process executing in a directory it normally doesn't execute, a process accessing an external network resource, etc. These meta-events may be created by using various algorithms to cluster the extracted features 106. As new events come in, their individual feature space is calculated, and then assigned one or more labels based on the nearest clusters it belongs to. By converting the data to meta-events, an unbounded number of events can be processed while maintaining fast anomaly detection that allows the computer system 101 to compare and detect a suspicious change in behavior based on the accounts' past behavior.

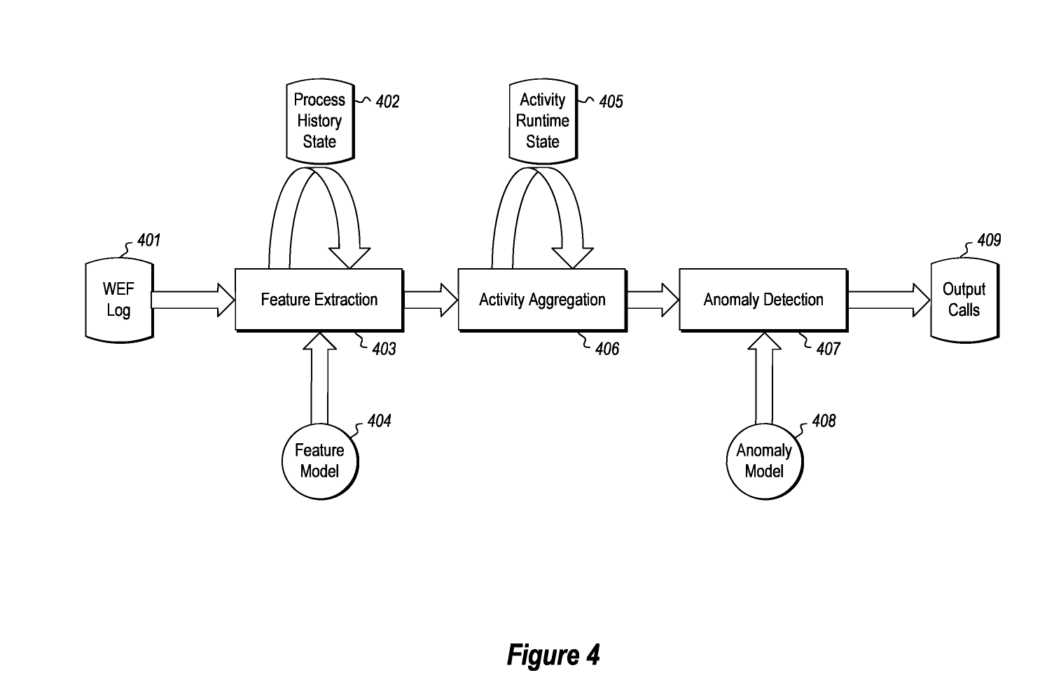

Security events generated by processes 109 may be processed from data residing in a local or external data store. This data may be received from internal security events that are forwarded, or from an agent that is installed locally on a machine and aggregates data to the computer system 101. Many different features may be calculated for each process execution. Some of the features are described herein; however, it will be understood that other features not listed herein may also be calculated to describe the execution characteristics of a process. As shown in FIG. 4, execution logs 401 may be fed into a feature extraction module 403 that accesses process state history 402 and a feature model 404 to extract process execution features. An activity aggregation module 406 then accesses activity runtime state 405 to determine how a given process is executing. An anomaly model 408 then performs anomaly detection 407 and identifies certain output calls 409 as being anomalous.

One feature may be a process name change or process directory change. For instance, if a process normally uses one name or directory, but then changes, it may indicate an abnormal execution. In one embodiment, this directory normality can be calculated using entropy, let dⱼ(xᵢ) be the observed counts for process xᵢ running in directory dⱼ. The process and directory entropy is then h(xᵢ)=Πⱼ log (p(dⱼ(xᵢ))*p(dⱼ(xᵢ)) where p(dⱼ(xᵢ)) is the empirical probability of process xᵢ being executed from directory dⱼ.

Another feature may include a process name or directory's relative frequency. Slightly different than the name/directory entropy, this feature represents the relative frequency of a process being run from a directory. Let p(x_{i,k}) be the probability of the number of times the process is run in a directory or the number of times a process is run total across an entity. This compliments entropy as processes with low entropy (i.e. process that are very consistent in where they are run), but with a small relative frequency (being executed in a directory it normally doesn't run), are abnormal.

Relative frequency of a process is another feature. This attribute is a measure that provides a value between 0-1 of the process executing. This measure is a function of the relative time the attribute has been seen in the past [X] number of days. This feature may be split into six different features: 1) Process extension, 2) Process directory, 3) Full process name 4) Name and extension 5) Machine domain 6) Machine name. In general processes, machines, domains, or directories that have been seen for more than four separate days over two separate weeks in a given time window (e.g. 30 days) have a value of one. Another feature may indicate whether a process command line contains a net address (e.g. \\machine-address) or an IP address. A parameter length feature represents the number of unique parameters of varying size that go into the command line.

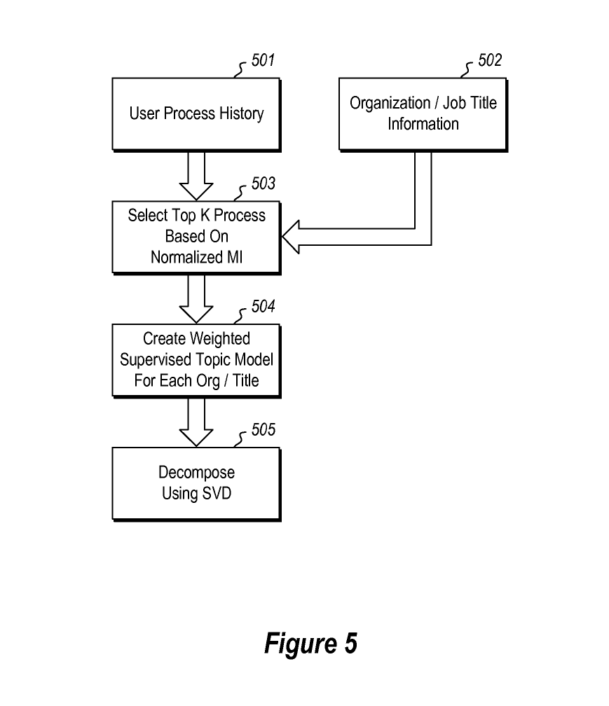

A neighbor process similarity feature provides neighbor process similarity value between 0-1000 that represents the general acceptability of a process being created by an individual based on the process name and the process history (as shown in step 501 of FIG. 5). This similarity measure captures behavior of what the account 113 will likely run in the future. For example, an account that installed SQL server will tend to run a variety of SQL based commands and utilities in the future. A process activity percentile level feature represents the log of the 50% and 95% of the counts of a process counts within a given day. This helps differentiate common, automated, or build commands from more interactive less scripted commands. An information bottleneck feature represents an embodiment where organizational and job title information are fused into the process by using an information bottleneck method to add additional information. This approach outputs a dimensional vector (e.g. 45 dimensions) for each process 109. The dimensional vector captures much of the job title and organization information for accounts that run the process.

The information bottleneck captures the user organizational and job title information into a separate feature. Information bottleneck methods may be used to capture discriminative process names based on other longitudinal data (e.g. job title, organization, company). At least some of the embodiments herein use a series of processing steps to reduce each individual process down to a 45 dimensional feature. This feature will then get processed into a 45 dimensional vector which is then aggregated with other vectors to form meta-events.

First, all possible combinations of organization and job title information are enumerated into a long feature binary vector denoted as y (as shown in step 502 of FIG. 5). Let x be a binary indicator for the process history for each individual for the top 100,000 processes. For each unique pairing, the computer system 101 calculates the mutual information between the job title/org indicator and the top 100,000 process names using balanced mutual information. The scores may be reweighted with a weighting value such as TF-IDF. An index value may also be used that returns the sorted decreasing order for the mutual information score within each group (503). The reweighting serves to preserve the observed mutual information score, while allowing for heavier weights for top ranked processes within an org/title grouping. This allows underrepresented org/title's to be more strongly weighted compared to heavy org/title combinations (504).

Next, as shown coefficients may bound together in a large matrix, and a singular value decomposition (SVD) may be performed done on the output (505). The coefficients for the SVD are passed in as features for the process (which eventual form meta-events). The information bottleneck approach reduces the process names to a grouping that is representative of the organization and title data.

In determining processes that are similar to one another, a neighbor process similarity calculation may be performed. The calculation begins with a user process reduction: A certain number of top common processes are selected, and a binary vector for any seen process for each user is created. This binary vector is reduced to a certain number of dimensions (e.g. 2,000 dimensions) using non-negative matrix factorization. This process may be performed in two adjacent time windows (e.g. 30 days each). Let xᵢ and xᵢ⁺ represent these two time windows. To prevent issues that may occur within a specific time window, each user may be randomly assigned a different time window from an overall larger (e.g. 180 day) time window.

Process similarity may be determined by clustering accounts' behavior based on their first (e.g. 30 day) time window xᵢ. In such an embodiment, let c(xᵢ) represent the nearest cluster for account i, and mₖ be the set of all processes in cluster k (xᵢεmₖ ifff c(xᵢ)=k). The next 30 day time window may be selected to separate cluster denoted as ĉ(xᵢ) and \hat{m}ₖ respectively for the cluster assignment and cluster sets respectively. For each individual, the mean vector difference is calculated between the current vector xᵢ and a sample of observations from the future cluster assignment lₖ˜U(\hat{m}_{ĉ(x}_{ᵢ}₎). Let dᵢ represent the average squared difference vector (dimension variance) between element xᵢ and the sampled future cluster values. This clustering is repeated multiple times with different random subsets of data to obtain a weighted averaged distance vector σᵢ²=d̅ᵢ(1−α)+ακ where d̅ᵢ is the sample mean over multiple clusterings—αε[0,1] and κ>0 are a missing ratio and base variance value respectively. Let d_{i,j}=xᵢΣᵢ^{0.5}Σⱼ^{0.5}xⱼ be the distance between elements i and j where Σ^{0.5} are the square root of the diagonal covariance matrix for elements. Similarity values may be assigned between elements xᵢ and xⱼ to be s(i,j)=λ(1−exp(−0.5*min(r_{i,j},r_{j,i}))+exp(−\sqrt{βᵢβⱼ}*d_{i,j}/2), and βᵢ and βⱼ are scaling factors to ensure each element has a sufficient number of elements (general these are calculated such that the similarity values of 1000^{th} most similar user by rank is 0.001).

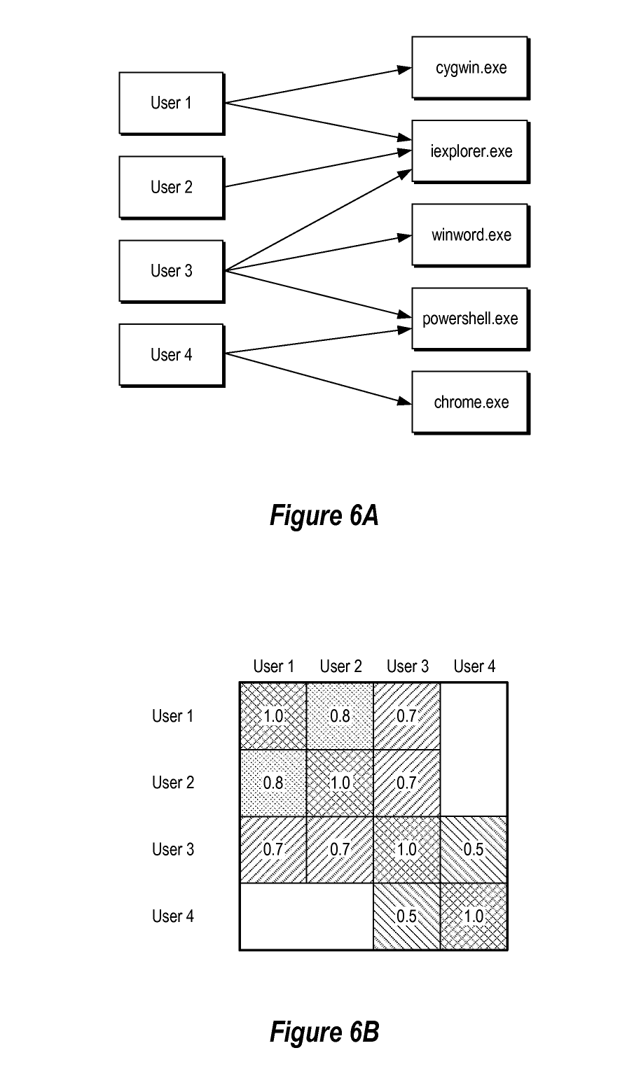

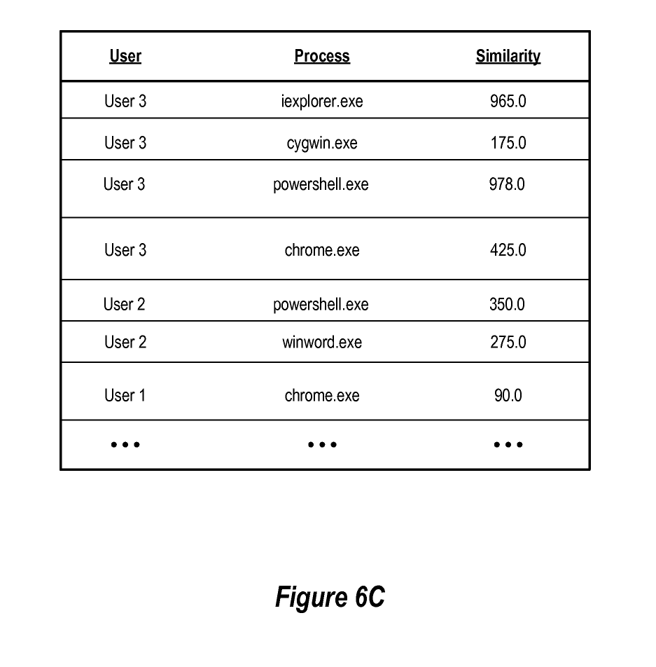

Process similarity may be calculated by running a random walk with restarts for each individual, as shown generally in FIGS. 6A-6C. At each step of the iteration, a user (e.g. user 1, 2, 3 or 4 in FIG. 6A) is randomly selected based on the proportional probability obtained from the above similarity. This process is run for a fixed length of time, and an aggregate set of processes visited is calculated (obtained by aggregating all processes from each user we visit). Let w_{i,n,m} be the location for the nth walk of user i at a depth of m, where O(w_{i,n,m}) is the set of all processes visited by the current walk state. T(w_{i,n}) is set to be all possible processes visited during walk n for account i. The walk score may be reduced to the maximal representations as

$${\hat{T}}_{k} ( {w}_{i , n} ) = {max}_{m} \{ {u}_{m} * I ( k , O ( {w}_{i , n , m} ) ) \} , where$$

$${u}_{m} = \{ \begin{matrix}1 , & m < 5 \\ 1 - {( \frac{m - 4}{15} )}^{2} , & otherwise\end{matrix}$$

is a decreasing score based on the walk depth m, and I(k, O(w_{i,n,m})) is an indicator representing whether process k is in the set of O(w_{i,n,m}).

In a neighborhood process approximation, the process neighborhood similarity is determined using a fast generalized linear model. A set of anchor or exemplar points are calculated from various accounts based on the similarity by clustering accounts based on their feature space. For each cluster group, a subset of users is sampled, and the union of the processes they have run in the past is determined. A similarity value is then calculated between all individuals and this cluster group based on a weighted Jaccard value. The output of the random walk is then approximated by fitting a linear model for each process based on the newly transformed feature space and the expected neighborhood process similarity as calculated from the random walk.

Evaluation at runtime can then be done in fast incremental manner by calculating the weighted Jaccard similarity between all exemplar points (in general this is done with a fast dictionary lookup as each updated reachability value only needs to compare the match of a single new process), transforming, and predicting the new value from the linear model. The output of the random walk can be interpreted as the acceptability of a running a process based on the past behavior of an individual and the past behavior of users similar to themselves (also based on the expected change in user behavior). The features are then run through a clustering algorithm to discretize the events into categories of events. Types of meta-events 108 include things such as: a net process that is pointing to an IP address/net address, new process created on a standard machine, new process created on a new machine, etc.

To facilitate capturing a wide range of meta-events 108, each event is assigned a soft cluster representation based on its proximity to a cluster center. Let xᵢ be the feature vector for a new process event, where cⱼ is the center for cluster j (determined by clustering all event types). We calculate the distance between all points and all cluster centers as d_{i,j}=∥xᵢ−c∥ as the Euclidean distance between point i and cluster j. The expression lᵢ(d_{i,j}) is defined to be a ranking function, which returns the overall rank between clusters based on increasing distance. Let r_{i,j}=exp(−0.5*d_{i,j}²/σ₁²) be a similarity measure where σ₁² is the average variance between cluster centers (determined during the initial training) A normalized similarity is declared as

$${u}_{i , j} = \frac{ρ ( {r}_{i , j} )}{{Σ}_{k} ρ ( {r}_{i , k} )} , where$$

$$ρ ( {r}_{i , j} ) = max ( 0 , {r}_{i , j} - max ( {r}_{i , j} ) - \{ 1 - exp ( - 3.0 * max ( 0 , {l}_{i} ( {d}_{i , j} ) - 2 ) ) \} - 0.1 )$$

adds a decreasing penalty function based on the rank of the centroid. The function serves to truncate the cluster membership to a sparse set of the most relevant clusters. By normalizing by the max value and subtracting 0.1, only clusters that have membership similarity within 0.1 of the max cluster are retained, and membership values that are far away are not included. Additionally, since a decreasing function is penalized based on the ranking of the similarity of the observation to the cluster, this ensures that only the top clusters are used to represent an event. This is computationally efficient as the computer system 101 only has to move around a small subset of cluster memberships during evaluation.

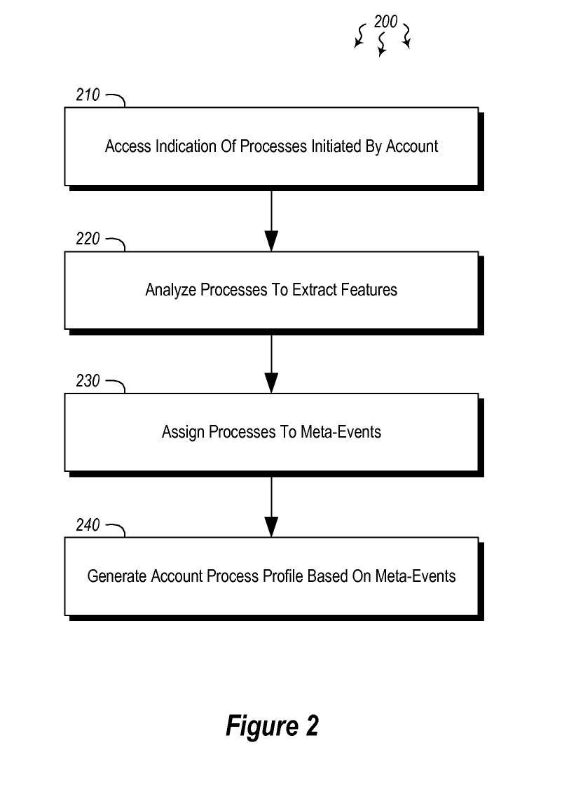

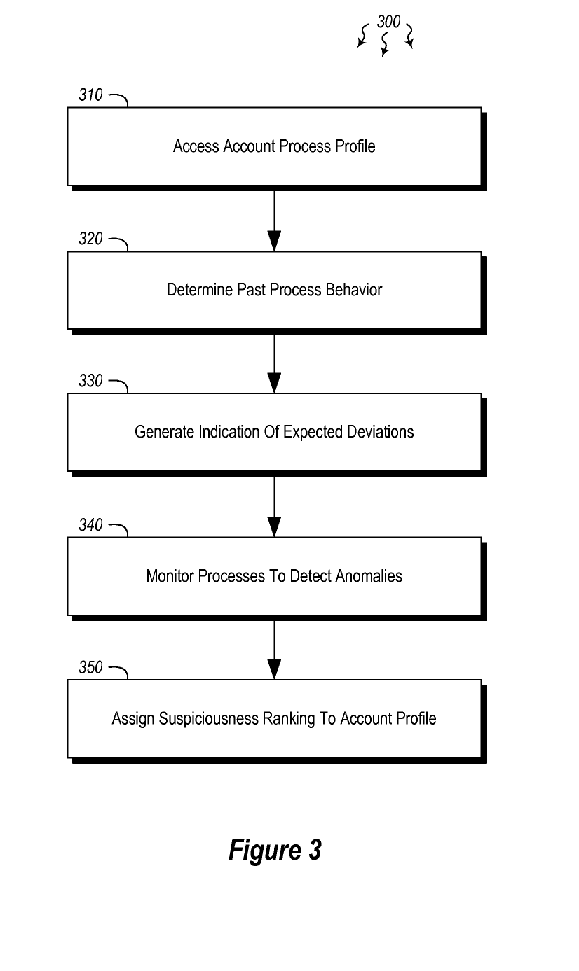

After converting the login behavior to meta-events, the data is then fed into an activity model. Activities are weighted and counted by the percentage of inclusion for each individual event. Detecting and reporting changes of user's activity behavior of a subfield of anomaly detection may be referred to as masquerading detection. Masquerading detection is often more involved than standard anomaly detection methods as it often includes building either specific models, or user specific invariant features to capture anomalous behavior. As a result, many methods that are designed for anomaly detection (e.g. standard outlier methods, time series prediction), don't scale well to building individualized anomaly detection. This is largely due to irregular or rare users, who, from a global perspective often behave differently from other users, but whose behavior is consistent across time. Often, users behave in bursts of activity, with large periods of inactivity. This makes it difficult to fit standard outlier methods, which often have expectations of an account being stationary in the user's behavior. These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for generating an account process profile based on meta-events. The method 200 will now be described with frequent reference to the components and data of environment 100.

Method 200 includes accessing an indication of which processes were initiated by an account over a specified period of time (210). For example, the communications module 104 of computer system 101 may access indication 114 which identifies which processes 109 were initiated by account 113 over a specified period of time (e.g. 30 days). As mentioned previously, the account 113 may be a user account, a system account, a service account, a local computer account or other type of account that allows the entity to initiate a process 109.

Method 200 further includes analyzing at least some of the processes identified in the indication to extract one or more features associated with the processes (220). The process analyzing module 105 may analyze one or more of the processes identified in the indication of processes 114 to extract features associated with the processes. These features may include a process that has a new process name, a process that is accessing a new directory, a process that is accessing certain folders (e.g. operating system folders), a process that initiates processes that are outside of that account's role (e.g. a developer executes processes that a financial worker likely would not, and vice versa), or other features. Many different features 106 may be identified and implemented in determining an account's process execution behavior.

Method 200 further includes assigning the processes to one or more meta-events based on the extracted features, each meta-event comprising a representation of how the processes are executed within the computer system (230). For example, the process assigning module 107 may assign the identified processes 109 to one or more meta-events 108. These meta-events are representations 110 of how the processes are executed within the computer system 101 (or within another computer system). The meta-events are provided to the account process profile generating module 111 which generates an account process profile for the account based on the meta-events (240). The account process profile provides a comprehensive view of the account's behavior over the specified period of time (240). In this manner, the embodiments described herein are not simply rule-based anomaly detectors, but rather build large user behavior profiles, determine expected movement, and calculate acceptable behavior ranges based on what other similar accounts have done.

The meta-events 108 may be aggregated to generate the account process profile 112 which provides a comprehensive view of the account's behavior over a specified period of time. As the term is used herein, a “comprehensive” view provides a full, complete or inclusive view of an account's behavior over time. The comprehensive view may be tailored to show certain information while omitting other information, and may still be a comprehensive view. A comprehensive view is thus designed to show each captured action performed by an account within a specified period of time. Then, based on past captured behavior, features 106 may be calculated to determine which processes a given account runs, which directories they run them from, which machines they run the processes from, what types of processes are executed. Each running of a process is assigned to a meta-event 108 which describes what the process looks like. These meta-events are then aggregated into an account process profile 112 which may then be used to detect anomalies in account behavior. These anomalies may assist in identifying suspicious or malicious account behavior, and may allow an administrator or application to more closely monitor that account and/or take action on that account such as terminating its ability to initiate processes or perform tasks.

In some cases, the generated account process profile for the account may be accessed to generate an expected behavior profile which provides a projected view of the account's future behavior over a future period of time. The expected behavior profile includes a dynamically variable window of acceptability indicating a specified tolerance for anomalous behavior. For example, if the tolerance window for a given account is three percent different than normal, and the window of acceptability is surpassed by one or more of the account's actions, then an alert may be triggered notifying an administrator or other user of the abnormal process use.

In some cases, the window of acceptability indicating the specified tolerance for anomalous behavior may be generated based on account process profiles generated for at least one other account that is determined to be similar to the account. As indicated above, similar accounts may be identified by performing a random walk. If these other, similar accounts have activity that is indicated as being normal, and another monitored account performs actions outside of this determined normal behavior, it will be flagged as anomalous. The window of acceptability may be dynamic and may change for each account in real-time. Some accounts may have a larger window of acceptability, while other accounts may have a much smaller window of acceptability. For instance, very consistent users/accounts may have a tighter range, while other less consistent users may have a looser range. The window of acceptability may be account-specific, user-specific, or group-specific, and may dynamically change for each account, user or group. In some embodiments, machine learning may be used to assign processes 109 to meta-events 108. As such, over time, process behavior may be learned and quantified for each meta-event.

Turning now to FIG. 3, a flowchart is illustrated of a method 300 for detecting account behavior anomalies based on account process profiles. The method 300 will now be described with frequent reference to the components and data of environment 100.

Method 300 includes accessing an account process profile that includes one or more meta-events, the meta-events comprising representations of how the process is executed within the computing system (310). For example, account process profile accessing module 116 may access account process profile 112. The account process profile 112 includes various meta-events 108 as described above in method 200. Each of these meta-events is a representation 110 of how the processes 109 are executed within computer system 101.

Method 300 further includes determining past process behavior for the account based on the accessed account process profile including which meta-events were present in the account process profile (320). The behavior determining module 117 may determine past process behavior 118 based on the accessed account process profile 112. The account process profile 112 includes (or references) meta-events 108 which may be used to determine process execution behavior. This process execution behavior may include any of the above-described features, as well as other characteristics of process execution related to a give process. The expected deviations determining module 119 may then generate an indication of expected deviations 120 for a specified future period of time (330). This indication of expected deviations 120 indicating a likelihood 121 that the account 113 will initiate a process that is outside of the account's past behavior, or is outside of behavior of at least one account similar to the account. The likelihood may thus indicate, based on the past behavior) that there is a high likelihood that the account will execute a process outside of their past behavior (or that of a similar account), or may indicate that there is a low likelihood of such behavior. The likelihood may be specific or general, may include various levels or degrees of likelihood, and may be unique to each account or to a group of accounts.

Method 300 further includes monitoring those processes that are initiated by the account over the specified future period of time to detect anomalies (340) and, based on the detected anomalies 123, assigning a suspiciousness ranking to the account profile (350). The process monitoring module 122 may thus monitor those processes that are determined to be anomalous or those accounts that are initiating anomalous processes. Administrators may be notified of such accounts or processes so that they are aware of activity that is not normal for that account or for similar accounts. The ranking module 124 may assign a suspiciousness ranking 115 to the account process profile, indicating how suspicious its activities are.

In some cases, one or more alerts may be generated for account profiles with a suspiciousness ranking that is beyond a specified threshold value. Still further, as mentioned above, the indication of expected deviations 120 may include a dynamically variable acceptability window that indicates how far outside of the account's past behavior the account can go before being flagged as anomalous. Monitoring those processes that are initiated by the account over the specified future period of time to detect anomalies may include teasing apart behavior of the account from behavior of a masquerading account. In cases of masquerading users, a user executes normal processes, and another user adds on to the normal process. In such cases, the computer system 101 separates and alerts on the behavior of the malicious activity from the normal users behavior.

An anomaly detection model may be trained using existing stored account profiles 112. In this manner, a fast approximation may be performed on future account process initiations. The anomaly model may be trained offline, and then implemented to perform very fast, efficient online approximations. In such cases, stored profiles are created and anomaly models are built based on the stored profiles. Then, new parameters (e.g. range of movement parameters) are interpolated for new users without having to perform background processing. Performing a fast approximation may thus include interpolating range of movement parameters for new users without performing at least a portion of background processing. In some cases, domain-specific information may be used to generate the indication of expected deviations for the specified future period of time. The domain may include an account's user name or role. The account's process profile may thus shift into a new process behavior profile if the account receiving a new role. Accordingly, a user tied to an account may receive a promotion or new job requirements which lead the user to execute different processes. This may be taken into account so that the user's new process executions are not flagged as anomalous.

Claims support: One embodiment includes a computer system including at least one processor. The computer system performs a computer-implemented method for generating an account process profile based on meta-events, where the method includes: accessing an indication of which processes 114 were initiated by an account 113 over a specified period of time, analyzing at least some of the processes 109 identified in the indication to extract one or more features 106 associated with the processes; assigning the processes to one or more meta-events 108 based on the extracted features, each meta-event comprising a representation 110 of how the processes are executed within the computer system 101, and generating an account process profile 112 for the account based on the meta-events, the account process profile providing a view of the account's behavior 118 over the specified period of time.

The computer-implemented method further includes implementing the account process profile to detect one or more anomalies in account behavior. The computer-implemented method also includes accessing the generated account process profile for the account to generate an expected behavior profile which provides a projected view of the account's future behavior over a future period of time. The expected behavior profile includes a dynamically variable window of acceptability indicating a specified tolerance for anomalous behavior. An alert is triggered upon determining that the window of acceptability has been surpassed by one or more of the account's actions. Machine learning is used to assign the processes to meta-events, such that over time, process behavior is learned and quantified for each meta-event. In some cases, the meta-events are aggregated to generate the account process profile which provides a comprehensive view of the account's behavior over the specified period of time. The window of acceptability indicating the specified tolerance for anomalous behavior is generated based on account process profiles generated for at least one other account that is determined to be similar to the account.

Another embodiment includes a computer program product for implementing a method for detecting account behavior anomalies based on account process profiles. The computer program product comprises one or more computer-readable storage media having stored thereon computer-executable instructions that, when executed by one or more processors of a computing system, cause the computing system to perform the method, which includes the following: accessing an account process profile 112 that includes one or more meta-events 108, the meta-events comprising representations 110 of how the process is executed within the computing system 101, determining past process behavior 118 for the account 113 based on the accessed account process profile including which meta-events were present in the account process profile, generating an indication of expected deviations 120 for a specified future period of time, the expected deviations indicating a likelihood 121 that the account will initiate a process that is outside of the account's past behavior, or is outside of behavior of at least one account similar to the account, monitoring those processes that are initiated by the account 113 over the specified future period of time to detect anomalies 123, and, based on the detected anomalies, assigning a suspiciousness ranking 115 to the account profile.

In some cases, alerts are generated for account profiles with a suspiciousness ranking that is beyond a specified threshold. The indication of expected deviations includes a dynamically variable acceptability window that indicates how far outside of the account's past behavior the account can go before being flagged as anomalous. An anomaly detection model may be trained using existing stored account profiles, such that a fast approximation may be performed on future account process initiations. Performing a fast approximation includes interpolating range of movement parameters for new users without performing at least a portion of background processing.

In another embodiment, a computer system is provided, where the computer system includes the following: one or more processors, an account process profile accessing module 116 for accessing an account process profile 112 that includes one or more meta-events 108, the meta-events comprising representations 110 of how the process 109 is executed within the computing system 101, a behavior determining module 117 for determining past process behavior 118 for the account based on the accessed account process profile 112 including which meta-events were present in the account process profile, an expected deviations determining module 119 for generating an indication of expected deviations 120 for a specified future period of time, the expected deviations indicating a likelihood 121 that the account will initiate a process that is outside of the account's past behavior, or is outside of behavior of at least one account similar to the account, a process monitoring module 122 for monitoring those processes that are initiated by the account over the specified future period of time to detect anomalies 123, and a ranking module 124 for assigning a suspiciousness ranking 115 to the account profile based on the detected anomalies 123. In some cases, domain-specific information is used to generate the indication of expected deviations for the specified future period of time.

Accordingly, methods, systems and computer program products are provided which generate an account process profile based on meta-events. Moreover, methods, systems and computer program products are provided which detect account behavior anomalies based on account process profiles.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. At a computer system including at least one processor, a computer-implemented method for generating an account process profile based on meta-events, the method comprising:
accessing an indication of which processes were initiated by an account over a specified period of time;
analyzing at least some of the processes identified in the indication to extract one or more features associated with the processes;
assigning the processes to one or more meta-events based on the extracted features, each meta-event comprising a representation of how the processes are executed within the computer system; and
generating an account process profile for the account based on the meta-events, the account process profile providing a view of the account's behavior over the specified period of time.

2. The method of claim 1, further comprising implementing the account process profile to detect one or more anomalies in account behavior.

3. The method of claim 1, wherein the account comprises a user account, a system account, a service account, or a local computer account.

4. The method of claim 1, further comprising accessing the generated account process profile for the account to generate an expected behavior profile which provides a projected view of the account's future behavior over a future period of time.

5. The method of claim 4, wherein the expected behavior profile includes a dynamically variable window of acceptability indicating a specified tolerance for anomalous behavior.

6. The method of claim 5, further comprising triggering an alert upon determining that the window of acceptability has been surpassed by one or more of the account's actions.

7. The method of claim 5, wherein the window of acceptability indicating the specified tolerance for anomalous behavior is generated based on account process profiles generated for at least one other account that is determined to be similar to the account.

8. The method of claim 5, wherein the window of acceptability is different for different accounts and account groups, and dynamically changes within individual accounts and account groups.

9. The method of claim 1, wherein machine learning is used to assign the processes to meta-events, such that over time, process behavior is learned and quantified for each meta-event.

10. The method of claim 9, wherein each meta-event includes processes with a specified set of one or more features or characteristics.

11. The method of claim 1, wherein the meta-events are aggregated to generate the account process profile which provides a comprehensive view of the account's behavior over the specified period of time.

12. A computer program product for implementing a method for detecting account behavior anomalies based on account process profiles, the computer program product comprising one or more computer-readable storage media having stored thereon computer-executable instructions that, when executed by one or more processors of a computing system, cause the computing system to perform the method, the method comprising:
accessing an account process profile that includes one or more meta-events, the meta-events comprising representations of how the process is executed within the computing system;
determining past process behavior for the account based on the accessed account process profile including which meta-events were present in the account process profile;
generating an indication of expected deviations for a specified future period of time, the expected deviations indicating a likelihood that the account will initiate a process that is outside of the account's past behavior, or is outside of behavior of at least one account similar to the account;
monitoring those processes that are initiated by the account over the specified future period of time to detect anomalies; and
based on the detected anomalies, assigning a suspiciousness ranking to the account profile.

13. The computer program product of claim 12, wherein one or more alerts are generated for account profiles with a suspiciousness ranking that is beyond a specified threshold.

14. The computer program product of claim 12, wherein the indication of expected deviations includes a dynamically variable acceptability window that indicates how far outside of the account's past behavior the account can go before being flagged as anomalous.

15. The computer program product of claim 12, wherein monitoring those processes that are initiated by the account over the specified future period of time to detect anomalies comprises teasing apart behavior of the account from behavior of a masquerading account.

16. The computer program product of claim 12, further comprising training an anomaly detection model using existing stored account profiles, such that a fast approximation may be performed on future account process initiations.

17. The computer program product of claim 16, wherein performing a fast approximation comprises interpolating range of movement parameters for new users without performing at least a portion of background processing.

18. A computer system comprising the following:
one or more processors;
an account process profile accessing module for accessing an account process profile that includes one or more meta-events, the meta-events comprising representations of how the process is executed within the computing system;
a behavior determining module for determining past process behavior for the account based on the accessed account process profile including which meta-events were present in the account process profile;
an expected deviations determining module for generating an indication of expected deviations for a specified future period of time, the expected deviations indicating a likelihood that the account will initiate a process that is outside of the account's past behavior, or is outside of behavior of at least one account similar to the account;
a process monitoring module for monitoring those processes that are initiated by the account over the specified future period of time to detect anomalies; and
a ranking module for assigning a suspiciousness ranking to the account profile based on the detected anomalies.

19. The computer system of claim 18, wherein domain-specific information is used to generate the indication of expected deviations for the specified future period of time.

20. The computer system of claim 18, wherein an account's process profile shifts into new process behavior profile upon the account receiving a new role.
